(19) United States
(12) Patent Application Publication
(10) Pub. No.: US 2005/0009955 A1
(43) Pub. Date: Jan. 13, 2005

(54) Composite of silica reacted with blocked mercaptoalkoxysilane and alkyl silane, rubber composition with said composite, and article having component thereof

(76) Inventor: Martin Paul Cohen, Fairlawn, OH (US)

Correspondence Address: THE GOODYEAR TIRE & RUBBER COMPANY;INTELLECTUAL PROPERTY DEPARTMENT 823, 1144 EAST MARKET STREET, AKRON, OH, 44316-0001, US

(21) Appl. No.: 10/606,075

(22) Filed: Jun. 25, 2003

(51) Int. Cl. C09K 3/00; C08K 3/34; C08K 9/06

(52) U.S. Cl. 523/212; 106/481; 524/492

(57) ABSTRACT

The invention relates to amorphous silica (e.g. silica aggregates) having hydroxyl groups (e.g. silanol groups) on its surface which has been pre-reacted (e.g. pre-hydrophobated) with a combination of blocked mercaptoalkoxysilane coupling agent and an alkyl silane to form a composite. The invention further relates to a rubber composition which contains such composite, particularly as reinforcement. The invention additionally relates to article of manufacture, such as for example a tire, having at least one component of such rubber composition. The blocked mercaptoalkoxysilane is composed of a mercaptosilane where the hydrogen moiety of the mercaptan moiety is substituted with a blocking moiety which allows the alkoxy groups of the mercaptoalkoxyosilane to react with a precipitated silica having hydroxyl groups (e.g. silanol groups) on its surface for the silica pre-treatment thereof yet renders the mercapto portion of the mercaptoalkoxysilane as being relative inert insofar as subsequent coupling reaction with the elastomers until the blocked mercapto portion of the mercaptoakoxysilane becomes unblocked. Further, generation and release of reaction byproducts (e.g. alcohols) caused by reaction of alkoxy groups of the mercaptoalkoxysilane and byproducts from reaction of alkoxy or halogen groups of the alkylsilane with the hydroxyl groups of the amorphous silica is basically relegated to the pretreatment (said pre-reaction) of the blocked mercaptoalkoxysilane and alkylsilane with the silica and thereby essentially dissociated from and consequently eliminated, or at least minimized, during the actual subsequent mixing with the elastomer(s). Upon subsequent unblocking of the blocked mercapto moiety of the mercaptoalkoxysilane of the pre-hydrophobated silica within the rubber composition during the subsequent vulcanization of the rubber composition at an elevated temperature, the silica becomes coupled via the mercapto group of the mercaptoalkoxysilane to one or more elastomers of the rubber composition.

The invention relates to amorphous silica (e.g. silica aggregates) having hydroxyl groups (e.g. silanol groups) on its surface which has been pre-reacted (e.g. pre-hydrophobated) with a combination of blocked mercaptoalkoxysilane coupling agent and an alkyl silane to form a composite. The invention further relates to a rubber composition which contains such composite, particularly as reinforcement. The invention additionally relates to article of manufacture, such as for example a tire, having at least one component of such rubber composition. The blocked mercaptoalkoxysilane is composed of a mercaptosilane where the hydrogen moiety of the mercaptan moiety is substituted with a blocking moiety which allows the alkoxy groups of the mercaptoalkoxyosilane to react with a precipitated silica having hydroxyl groups (e.g. silanol groups) on its surface for the silica pre-treatment thereof yet renders the mercapto portion of the mercaptoalkoxysilane as being relative inert insofar as subsequent coupling reaction with the elastomers until the blocked mercapto portion of the mercaptoakoxysilane becomes unblocked. Further, generation and release of reaction byproducts (e.g. alcohols) caused by reaction of alkoxy groups of the mercaptoalkoxysilane and byproducts from reaction of alkoxy or halogen groups of the alkylsilane with the hydroxyl groups of the amorphous silica is basically relegated to the pretreatment (said pre-reaction) of the blocked mercaptoalkoxysilane and alkylsilane with the silica and thereby essentially dissociated from and consequently eliminated, or at least minimized, during the actual subsequent mixing with the elastomer(s). Upon subsequent unblocking of the blocked mercapto moiety of the mercaptoalkoxysilane of the pre-hydrophobated silica within the rubber composition during the subsequent vulcanization of the rubber composition at an elevated temperature, the silica becomes coupled via the mercapto group of the mercaptoalkoxysilane (the mercaptoalkoxysilane being attached to the silica since its alkoxy group has been previously been pre-reacted with the silica prior to addition to the elastomer) to one or more elastomers of the rubber composition.

### BACKGROUND OF THE INVENTION

Tires may be prepared with a rubber component which contains a precipitated silica which is hydrophobated in situ within the elastomer host by addition of both an organomercaptosilane and an alkyl silane. For example, see U.S. Pat. No. 4,474,908.

Tires may also be prepared with a rubber component in which both an organosilyl polysulfide and an alkylsilane are individually added to a silica-containing rubber composition to treat the amorphous silica in-situ within the rubber host with both a hydrophobating agent (the alkylsilane) and a silica coupler (the organosilyl polysulfide compound). For example, see U.S. Pat. No. 5,780,538.

Tires may further be prepared with a rubber component which contains a precipitated silica which has been pre-treated with a combination of organomercaptosilane and alkylsilane prior mixing with the rubber composition. For example, see U.S. Pat. No. 6,573,324.

Tires may also be prepared with a rubber component which contains a blocked organomercaptosilane as a coupling agent to aid in coupling the silica to one or more diene-based elastomers in which an unblocking agent is used to unblock the blocked organomercaptosilane within the rubber composition. For example, see WO 99/09036 patent publication and U.S. Pat. No. 6,127,468. Organomercaptosilane coupling agents are indicated as presenting superior coupling activity for coupling synthetic silica to various diene-based elastomers. However, apparently their relatively high chemical reactivity can lead to unacceptably high viscosities of the associated rubber compositions during processing as well as a usually disagreeable odor. Mercaptosilane derivatives are presented in which the mercapto group is blocked by replacing the mercapto hydrogen group by another group (the blocking group) to reduce the chemical activity of the mercapto group of the mercaptosilane. The blocking group generally contains an unsaturated heteroatom or a carbon which is chemically bound directly to the sulfur atom of the mercapto group by a single bond. Such blocking group may also be comprised of one or more carboxylate ester or carboxylic acid functional groups. Such blocked mercaptosilanes may be used in the preparation of synthetic amorphous silica reinforced diene-based elastomer compositions in which they are unblocked by an unblocking agent in situ within the rubber composition.

However, the blocked organomercaptosilane is required to be blended with amorphous silica (e.g. precipitated silica) and elastomers in a rubber mixing apparatus (e.g. an internal rubber mixer) and thereby involves both production and emission of alcohol and or other byproduct(s) in situ within the rubber composition by the reaction of the still blocked organomercaptosilane (prior to its unblocking) with hydroxyl groups contained on the surface of the amorphous silica (e.g. precipitated silica aggregates). The resulting rubber composition also contains such byproducts.

It is a significant aspect of this invention to circumvent, disengage and thereby eliminate, or at least minimize, such byproduct, particularly alcohol byproduct, formation and emission in situ within the rubber composition during the elastomer mixing phase.

Accordingly, it is an aspect of this invention to pre-treat a precipitated silica which contains alcohol groups (e.g. silanol groups) on its surface with a combination of a blocked mercaptoalkoxyosilane and an alkyl silane prior to mixing the precipitated silica and the blocked mercaptoalkoxysilane with the elastomer(s).

In practice, it is recognized that precipitated silica aggregates are typically hydrophilic (water attracting) in nature and, in order to aid in dispersing the silica aggregates in various rubber compositions, it is sometimes desired to make the silica aggregates more hydrophobic (water repelling) in nature and therefore more compatible with the rubber. Accordingly, and as described in the aforesaid U.S. Pat. Nos. 4,474,908 and 5,780,538, a hydrophobating agent may be added to a rubber composition in addition to the precipitated silica to combine with the silica in-situ within the rubber host to make the silica more hydrophobic in nature.

However, it is considered herein, for tire tread applications where enhanced properties such as, for abrasion resistance, are often sought, and particularly where a good homogeneous dispersion in the rubber host is often sought, that an in-situ modification of the amorphous silica within a viscous rubber host on a hit and miss basis, under relatively harsh high sheer and high temperature conditions is a relatively inefficient procedure of modifying the amorphous silica for use in rubber compositions which are intended to be silica reinforced, particularly where both an organomercaptosilane and alkyl silane are used which would compete within the rubber composition for reaction sites on the silica surface.

Accordingly, it is proposed herein to provide a tire having a component comprised of a rubber composition which contains particulate pre-hydrophobated precipitated silica aggregates where the silica aggregates are added to, or mixed with, the rubber composition in a pre-hydrophobated form instead of more inefficiently subsequently hydrophobating the silica aggregates in situ within the elastomer host.

Historically, according to U.S. Pat. Nos. 5,708,069 and 5,789,514 a silica gel may be derived by hydrophobating a silica hydrogel with both an organomercaptosilane and alkyl silane and drying the product. The resulting hydrophobated silica gel may be blended with natural rubber and/or synthetic rubber. This invention is intended to be exclusive of recovered silica gels and is intended to be limited to precipitated silica aggregates.

Also, historically, according to U.S. Pat. No. 5,750,610, an organosilicate-modified silica gel may be hydrophobated with both an organomercaptosilane and alkyl silane and the dried, treated organosilicate-modified silica gel blended with natural rubber and/or synthetic rubber. This invention is intended to be exclusive of such modified silica gels.

A general description of silica gel and precipitated silica may be found, for example, in the Encyclopedia of Chemical Technology, Fourth Edition (1997), Volume 21, Kirk-Othmer, silica gel is described in Pages 1020 through 1023 as a “ . . . coherent, rigid, continuous three-dimensional network of spherical particles of colloidal silica.” Precipitated silica is described on Pages 1023 through 1026 as being
“ . . . composed of aggregates (or secondary particles) of ultimate (or primary) particles of colloidal-size silica that have not become linked in a massive gel network during the preparation process.”
   Further “Particulate silica powders have a more open structure with higher pore volume than do dried pulverized gels . . . ”.

The pre-hydrophobated precipitated silica aggregates for this invention are intended to be exclusive of silica gels of a three dimensional network of spherical particles as referenced in the above Encyclopedia of Chemical Technology.

A further descriptive discussion of silica gels and precipitated silicas may be found, for example, in U.S. Pat. No. 5,094,829 which, as such reference, is intended to be incorporated here in its entirety.

The proposal for this invention is for a tire having a component of a rubber composition which contains pre-hydrophobated precipitated silica aggregates of elementary silica particles instead of precipitated silica aggregates, which are hydrophobated in situ within the elastomer host with individually added hydrophobating compounds, prepared by treatment of a precipitated or colloidal, preferably precipitated, silica by both a blocked mercaptoalkoxysilane and an alkylsilane, is considered herein to be novel and a departure from past practice.

In the description of this invention, the term “phr” relates to parts by weight for a material or ingredient per 100 parts by weight elastomer(s)”. The terms “rubber” and “elastomer” may be used interchangeably unless otherwise indicated. The terms “cure” and “vulcanize” may be used interchangeably unless otherwise indicated.

### SUMMARY AND PRACTICE OF THE INVENTION

In accordance with this invention, a process of preparing a hydrophobated amorphous silica composite comprises reacting an amorphous silica which contains hydroxyl groups (e.g. silanol groups) on its surface with a combination of a blocked mercaptoalkoxysilane and an alkylsilane (said alkoxysilane moiety of said mercaptoalkoxysilane and said alkoxysilane or haloalkane moiety of said alkylsilane thereby reacted with said hydroxyl groups on said amorphous silica);
wherein said alkylsilane is of the general formula (I):
   Zₙ-Si—R₄₋ₙ (I)
wherein R is a saturated alkyl radical having from one to 18, preferably from one to 8, carbon atoms such as, for example, methyl, ethyl, isopropyl, n-butyl and octadecyl radicals, n is a value of from 1 to 3 and Z is a radical selected from chlorine, bromine or alkoxy radicals wherein said alkoxy radicals is represented as (R¹O)—, wherein R¹ is a saturated alkyl radical having from one to 3 carbon atoms such as, for example, methyl, ethyl and isopropyl radicals, preferably at least one of methyl and ethyl radicals,
wherein said blocked mercaptoalkoxysilane is selected from blocked mercaptoalkoxysilanes of the general formulas (II-A) and (II-B):
   [[(ROC(═O))ₚ-(G)ⱼ]ₖ-Y—S]ᵣ-G-(SiX₃)ₛ (II-A)
   [(X₃Si)_{q}-G]ₐ-[Y—[S-G-SiX₃]_{b}]_{c} (II-B)
wherein Y is a polyvalent species (Q₂)A(=E) which is preferably a radical selected from the group consisting of —C(═NR)—; —SC(═NR)—; —SC(═O)—; (—NR)C(═O)—; (—NR)C(═S); —OC(═O)—; —OC(═S)—; —C(═O)—; —SC(═S)—; —C(═S)—; —S(═O); —OS(═O)₂—; (—NR)S(═O)₂—; —SS(═O)—; —OS(═O)—; (—NR)S(═O)—; —SS(═O)₂—; (—S)₂P(═O)—; —(—S)P(═O)—; —P(═S)(−)₂; (—NR)₂P(═O)—; (—NR)(—S)P(═O)—; (—O)₂P(═O)—; —(—O)P(═O)—; —(—NR)P(═O)—; (—NR)₂P(═S)—; (—NR)(—S)P═S)—; (—O)(—NR)P(═S)—; (—O)(—S)P(═S)—; (—O)₂P(═S)—; —(—O)P(═S)—; and —(—NR)P₉═S)—;
wherein the atom (A) is attached to the unsaturated heteroatom (E) which is attached to the sulfur, and the sulfur is linked via a group G to the silicon atom;
wherein each R is independently selected from hydrogen, and straight, cyclic or branched alkyl radicals containing from 1 to 18 carbon atoms and which may or may not contain unsaturation, alkenyl groups, aryl groups, aralkyl groups;
wherein each G is independently selected from a monovalent or polyvalent group derived from substitution of alkyl, alkenyl, aryl or aralkyl group(s) wherein G can contain from 1 to 18 carbon atoms, provided however that G is not such that said mercaptoalkoxysilane contains an alpha-, or beta-unsaturated carbonyl including a carbon-to-carbon double bond next to the thiocarbonyl group, wherein if G is univalent (e.g. if p=0), then G can be a hydrogen atom;
wherein X is independently selected from the group consisting of —Cl, -GR, RO—, RC(═O)—, R₂C═NO—, R₂NO—, or R₂N—, —R, —(OSiR₂), (OSiR₃), wherein each R and G is as above and at least one X is not —R;
wherein Q is selected from oxygen, sulfur or (—NR—);
wherein A is selected from carbon, sulfur, phosphorous or sulfonyl;
wherein E is selected from oxygen, sulfur or NR;
wherein p is 0 through 5; r is 1 through 3; z is 0 through 2; q is 0 through 6; a is 0 through 7; b is 1 through 3; j is 0 to 1, but j is 0 only if p is 1 and c is from 1 through 6, wherein j is preferably from 1 through 4; t is 0 through 5; s is 1 through 3; k is 1 or 2; and
wherein,
(A) if A is carbon, sulfur or sulfonyl, then
   (1) a+b=2 and
   (2) k=1;
(B) if A is phosphorus and a+b=c unless both
   (1) c>1 and
   (2) b=1, in which case a=c+1, and
(C) if A is phosphorus, then k is 2.

In additional accordance with this invention, said process of hydrophobating said amorphous includes removing chemical reaction byproducts, and particularly alcohol byproducts from reaction of the alkoxy group of the mercaptoalkoxysilane and alcohol and/or hydrogen halide byproducts from the reaction of the alkoxy and/or halogen groups of said alkylsilane with hydroxyl groups of said amorphous silica.

It is envisioned that said byproducts, which are typically conventionally water soluble, can be readily removed from the hydrophobated silica by water washing and/or water removal. The byproducts may also be removed by evaporation, distillation, or neutralization (in the case of hydrogen halides), based on their individual compositions and physical and chemical properties. The specific means of removal will be dependent on the nature of the byproducts.

In further accordance with this invention, a hydrophobated silica is provided by said process and particularly said hydrophobated silica which is substantially and preferably essentially free, of alcohol and hydrogen halide byproducts (formed by reacting said amorphous silica with said combination of mercaptoalkoxysilane and alkylsilane).

In further accordance with this invention, a process of preparing a rubber composition comprises the steps of:
(A) mixing at least one conjugated diene-based elastomer and said composite of hydrophobated amorphous silica (wherein said hydrophobated amorphous silica is substantially free, and preferably essentially free, of alcohol and hydrogen halide byproducts formed by pre-reaction with combination of said blocked mercaptoalkoxysilane and said alkylsilane prior to mixing with said elastomer);
(B) mixing an unblocking agent with the resulting mixture of step (A), and
(C) allowing the resulting mixture to sulfur vulcanize;
(wherein the chemical activity of the mercapto group of said mercaptoalkoxysilane is substantially, or basically entirely, blocked from interacting with said diene-based elastomer until said unblocking agent is added and allowed to subsequently unblock said blocked mercapto group of said blocked mercaptoalkoxysilane and thereby enable the unblocked mercapto group to interact with said diene-based elastomer),

Preferably the blocked mercaptoalkoxysilane is the blocked mercaptoalkoxysilane of Formula (II-A).

Preferably the blocked mercaptoalkoxysilane is the blocked mercaptoalkoxysilane of Formula (II-A) wherein r=1 and s=1.

For said blocked mercaptoalkoxysilane, Y is preferably —C(═O)—.

For said blocked mercaptoalkoxysilane, X is preferably RO—.

Said unblocking agent is preferably selected from at least one of N,N′-diphenylguanidine and N,N′-di-ortho-tolylguanidine.

It is to be appreciated that the said unblocking agent is a material capable of unblocking the blocked mercaptoalkoxysilane to enable the mercapto group, or moiety, of the mercaptoalkoxysilane to interact with the diene based elastomer(s). It is to be appreciated that choice of the unblocking agent will depend upon the blocking group, or moiety, used to block the chemical activity of the mercaptoalkoxysilane itself insofar as interacting with a diene-based elastomer is concerned, which would be readily understood by one having skill in such art.

In further accordance with this invention, a method of preparing a rubber composition comprises, based on parts by weight per 100 parts by weight (phr) of diene-based elastomer:
(A) mixing at least one conjugated diene-based elastomer with about 10 to about 120, alternately about 40 to about 100, phr of reinforcing filler at a temperature in a range of from about 140° C. to about 180° C., wherein said reinforcing filler is comprised of
   (1) a composite of said hydrophobated amorphous silica composite which is substantially free of alcohol and hydrogen halide byproducts formed by said pre-reaction with said blocked mercaptoalkoxysilane and said alkylsilane prior to mixing with said elastomer, and, optionally
   (2) at least one additional reinforcing filler selected from at least one of carbon black and an additional synthetic amorphous silica, preferably a precipitated silica;
(B) mixing an unblocking agent with the mixture of step (A), at a temperature in a range of from about 100° C. to about 125° C. and concurrently or thereafter mixing sulfur curative therewith at a temperature in a range of from about 100° C. to about 125° C., and thereafter
(C) curing the resulting mixture at an elevated temperature in range of from 140° C. to about 170° C.

In one aspect of the invention, said composite of pre-reacted (pre-hydrophobated) silica aggregates is prepared by pre-reacting
(A) silica in an aqueous colloidal form thereof, or, more preferably,
(B) amorphous (preferably precipitated) silica aggregates with said blocked mercaptoalkoxysilane and said alkylsilane, preferably in a weight ratio of said blocked mercaptoalkoxysilane to said alkylsilane in a range of from 10/90 to 90/10;

In further accordance with this invention, a rubber composition is provided which is prepared by the said process of this invention.

In additional accordance with this invention, an article of manufacture is provided having at least one component comprised of said rubber composition.

In further accordance with this invention, a tire is provided having at least one component comprised of said rubber composition.

In additional accordance with this invention, said tire component is a tire tread and particularly a tire tread intended to be a running surface of a tire.

Representative alkylsilanes of Formula (I) are, for example, trichloro methyl silane, dichloro dimethyl silane, chloro trimethyl silane, trimethoxy methyl silane, dimethoxy dimethyl silane, methoxy trimethyl silane, trimethoxy propyl silane, trimethoxy octyl silane, trimethoxy hexadecyl silane, dimethoxy dipropyl silane, triethoxy methyl silane, triethoxy propyl silane, triethoxy octyl silane, and diethoxy dimethyl silane.

Accordingly, said alkyl silanes may be alkoxy alkyl silanes with the alkoxy group being reactive with the hydroxyl groups (e.g. silanol groups) contained on the surface of precipitated silica aggregates.

Further accordingly, said alkyl silanes may be haloalkyl silanes with the halogen group (e.g. chlorine or bromine and preferably chlorine) being reactive with the hydroxyl groups (e.g. silanol groups) contained on the surface of precipitated silica aggregates.

In practice, for said blocked mercaptoalkoxysilane, the term “alkyl” is intended to include straight chain, branched chain and cyclic alkyl groups; the term “alkenyl” is intended to include straight chain, branched chain and cyclic alkenyl groups containing one or more carbon-to-carbon double bonds. Representative examples of such alkyl groups are, for example, methyl, ethyl, propyl, and isobutyl groups. Representative examples of aralkyl groups are, for example, phenyl, tolyl and phenethyl groups.

The term “cyclic alkyl” or “cyclic alkenyl” is intended to also include bicyclic and higher cyclic structures, as well as cyclic structures which are further substituted with alkyl groups. Representative of such groups are intended to include, for example, norbornyl, norbornenyl, ethylnorbornyl, ethylnorbornenyl, ethylcyclohexyl, ethylcyclohexenyl, and cyclohexylcyclohexyl groups.

Representative of preferred blocked mercaptoalkoxysilanes are, for example, mercaptoalkoxysilanes where Y is R(C═O)—, where R has a primary carbon attached to the carbonyl as an alkyl group which contains from 2 to 12, preferably from 6 through 8, carbon atoms; where X₃ is SiGSC(═O)GC(═O)SGSiX₃ and where G is a divalent hydrocarbon radical.

Representative examples of G are, for example, —(CH₂)ₙ— radicals where n is a value of from 1 to 12, diethylene cyclohexane, 1,2,4-triethylene cyclohexane, and diethylene benzene radicals. In practice, it is preferred that the sum of the carbon atoms within the G groups within the molecule is from 3 to 18, more preferably from 6 to 14. It is considered herein that such amount of carbon atoms in the blocked mercaptoalkoxysilane may aid in facilitating the dispersion of the composite of pre-reacted silica into the diene-based elastomer(s), whereby it is envisioned that a balance of physical of properties in the cured reinforced elastomer(s) is improved.

In practice, the R groups of the blocked mercaptoalkoxysilane are preferably selected from hydrogen atom and alkyl groups having from 1 through 4 carbon atoms.

Representative examples of X are, for example, methoxy, ethoxy, isobutoxy, propoxy, isopropoxy, acetoxy and oximato groups. Preferably, X is selected from methoxy, acetoxy and ethoxy groups. In practice, at least one X must be reactive (i.e., hydrolyzable).

In practice, for preferred blocked mercaptoalkoxysilanes, p is a value of 0 through 2; X is RO— or RC(═O)O—; R is a hydrogen, phenyl, isopropyl, cyclohexyl, or isobutyl radical; and G is a substituted phenyl or substituted straight chain alkyl radical having from 2 to 12 carbon atoms. For a more preferred block mercaptoalkoxysilane, the value of p is zero; X is an ethoxy group and G is an alkyl group which contains from 3 to 12 carbon atoms.

Representative examples of various blocked mercaptoalkoxy silanes are, for example, 2-triethoxysilyl-1-ethyl thioacetate; 2-trimethoxysilyl-1-ethyl thioacetate; 2-(methyldimethoxysilyl)-1-ethyl thioacetate; 3-trimethoxysilyl-1-propyl thioacetate; triethoxysilylmethyl thioacetate; trimethoxysilylmethyl thioacetate; triisopropoxysilylmethyl thioacetate; methyldiethoxysilylmethyl thioacetate; methyldimethoxysilylmethyl thioacetate; methyldiisopropoxysilylmethyl thioacetate; dimethylethoxysilylmethyl thioacetate; dimethylmethoxysilylmethyl thioacetate; dimethylisopropoxysilylmethyl thioacetate; 2-triisopropoxysilyl-1-ethyl thioacetate; 2-(methyldiethoxysilyl)-1-ethyl thioacetate; 2-(methyldiisopropoxysilyl)-1-ethyl thioacetate; 2-(dimethylethoxysilyl)-1-ethyl thioacetate; 2-(dimethylmethoxysilyl)-1-ethyl thioacetate; 2-(dimethylisopropoxysilyl)-1-ethyl thioacetate; 3-triethoxysilyl-1-propyl thioacetate; 3-triisopropoxysilyl-1-propyl thioacetate; 3-methyldiethoxysilyl-1-propyl thioacetate; 3-methyldimethoxysilyl-1-propyl thioacetate; 3-methyldiisopropoxysilyl-1-propyl thioacetate; 1-(2-triethoxysilyl-1-ethyl)-4-thioacetylcyclohexane; 1-(2-triethoxysilyl-1-ethyl)-3-thioacetylcyclohexane; 2-triethoxysilyl-5-thioacetylnorbornene; 2-triethoxysilyl-4-thioacetylnorbornene; 2-(2-triethoxysilyl-1-ethyl)-5-thioacetylnorbornene; 2-(2-triethoxysilyl-1-ethyl)-4-thioacetylnorbornene; 1-(1-oxo-2-thia-5-triethoxysilylpenyl)benzoic acid; 6-triethoxysilyl-1-hexyl thioacetate; 1-triethoxysilyl-5-hexyl thioacetate; 8-triethoxysilyl-1-octyl thioacetate; 1-triethoxysilyl-7-octyl thioacetate; 6-triethoxysilyl-1-hexyl thioacetate; 1-triethoxysilyl-5-octyl thioacetate; 8-trimethoxysilyl-1-octyl thioacetate; 1-trimethoxysilyl-7-octyl thioacetate; 10-triethoxysilyl-1-decyl thioacetate; 1-triethoxysilyl-9-decyl thioacetate; 1-triethoxysilyl-2-butyl thioacetate; 1-triethoxysilyl-3-butyl thioacetate; 1-triethoxysilyl-3-methyl-2-butyl thioacetate; 1-triethoxysilyl-3-methyl-3-butyl thioacetate; 3-trimethoxysilyl-1-propyl thiooctoate; 3-triethoxysilyl-1-propyl thiopalmitate; 3-triethoxysilyl-1-propyl thiooctoate; 3-triethoxysilyl-1-propyl thiobenzoate; 3-triethoxysilyl-1-propyl thio-2-ethylhexanoate; 3-methyldiacetoxysilyl-1-propyl thioacetate; 3-triacetoxysilyl-1-propyl thioacetate; 2-methyldiacetoxysilyl-1-ethyl thioacetate; 2-triacetoxysilyl-1-ethyl thioacetate; 1-methyldiacetoxysilyl-1-ethyl thioacetate; 1-triacetoxysilyl-1-ethyl thioacetate; 3-ethoxydidodecyloxy-1-propyl thioacetate; 3-ethoxyditetradecyloxy-1-propyl thioacetate; 3-ethoxydidodecyloxy-1-propyl-thiooctoate; 3-ethoxyditetradecyloxy-1-propyl-thiooctoate; tris-(3-triethoxysilyl-1-propyl)trithiophosphate; bis-(3-triethoxysilyl-1-propyl)methyldithiophosphonate; bis-(3-triethoxysilyl-1-propyl)ethyldithiophosphonate; 3-triethoxysilyl-1-propyldimethylthiophosphinate; 3-triethoxysilyl-1-propyldiethylthiophosphinate; tris-(3-triethoxysilyl-1-propyl)tetrathiophosphate; bis-(3-triethoxysilyl-1-propyl)methyltrithiophosphonate; bis-(3-triethoxysilyl-1-propyl)ethyltrithiophosphonate; 3-triethoxysilyl-1-propyldimethyldithiophosphinate; 3-triethoxysilyl-1-propyldiethyldithiophosphinate; tris-(3-methyldimethoxysilyl-1-propyl)trithiophosphate; bis-(3-methyldimethoxysilyl-1-propyl)methyldithiophosphonate; bis-(3-methyldimethoxysilyl-1-propyl)ethyldithiophosphonate; 3-methyldimethoxysilyl-1-propyldimethylthiophosphinate; 3-methyldimethoxysilyl-1-propyldiethylthiophosphinate; 3-triethoxysilyl-1-propylmethylthiosulphate; 3-triethoxysilyl-1-propylmethanethiosulphonate; 3-triethoxysilyl-1-propylethanethiosulphonate; 3-triethoxysilyl-1-propylbenzenethiosulphonate; 3-triethoxysilyl-1-propyltoluenethiosulphonate; 3-triethoxysilyl-1-propylnaphthalenethiosulphonate; 3-triethoxysilyl-1-propylxylenethiosulphonate; triethoxysilylmethylmethylthiosulphate; triethoxysilylmethylmethanethiosulphonate; triethoxysilylmethylethanethiosulphonate; triethoxysilylmethylbenzenethiosulphonate; triethoxysilylmethyltoluenethiosulphonate; triethoxysilylmethylnaphthalenethiosulphonate; triethoxysilylmethylxylenethiosulphonate.

In practice, mixtures of various blocked mercaptoalkoxysilanes may be used, particularly where synthetic methods of their preparation results in a mixture of resultant mercaptoalkoxysilanes or where mixtures of blocked mercaptosilanes are intentionally used for their various functionalities. In one aspect, it is understood that the partial hydrolyzates of the blocked mercaptoalkoxysilanes (e.g. blocked mercaptoalkoxysiloxanes) may also be encompassed by the blocked mercaptoalkoxysilanes herein, in that such partial hydrolyzates will be a side product of most methods of manufacture of the blocked mercaptoalkoxysilane or can occur upon storage of the blocked mercaptoalkoxysilane, especially in moist, humid conditions.

Various methods of preparation of various blocked mercaptoalkoxysilanes may be found, for example, in PCT/US98/17391 U.S. Pat. No. 3,692,812 patent publications as well as in various literature publications such as, for example, in Gornowicz, G., “Preparation of Silylalkanethiols”, J. Org. Chem., Volume 33, No. 7, July, 1968; Vorkonov, M. G., et al., Trialkoxysilylalkanethiols and Bis(trialkoxysilylakyl)sulfides, Izvestiya Akademii Nauk SSSR and Seriya Khimicheskeya, No. 8, Pages 1849 through 1851, August 1977.

In practice, the blocked mercaptoalkoxysilanes for use in this invention are used first, as a component in the preparation of a chemically treated, hydrophobated silica (e.g. precipitated silica) composite and, secondly, as a resultant component of such composite, as a coupling agent to couple the amorphous silica (which contains hydroxyl groups on its surface) to various diene-based elastomers (which contain carbon-to-carbon double bonds). The blocked mercaptoalkoxysilanes are seen herein as enabling the use of both a relatively high efficiency of the alkoxysilane for pre-reacting with the amorphous silica (preferably a precipitated silica) and a relatively high efficiency of the mercapto group for subsequent mixing with and then interacting with the elastomer(s) when it becomes unblocked without the detrimental side effects typically associated with the use of mercaptosilanes, such as pre-mature high processing viscosity of the rubber composition for an unblocked mercaptoalkoxysilane and odor. These benefits are accomplished because the mercaptan group initially is non-reactive because of the blocking group. The blocking group substantially prevents the mercapto group of the mercaptoalkoxysilane from prematurely coupling to the diene-based elastomer(s) polymer during the mixing of the rubber ingredients. Thus, in practice, the reaction of the alkoxysilane group with the amorphous silica is conducted and completed during the pre-treatment step of combining the silica with the combination of alkylsilane and blocked mercaptoalkoxysilane composition. Mixing of the pre-treated amorphous silica with the diene-based elastomer(s) is then done and substantial coupling of the pre-treated silica with the diene-based elastomer(s) is avoided until later in the rubber processing and possibly delayed until the actual curing of the rubber composition at the elevated temperature, thereby minimizing the undesirable premature curing (scorch) and the associated undesirable increase in viscosity of the rubber composition itself during the mixing stage and possibly subsequent processing stage(s), such as for example processing of the mixed rubber composition to form shaped, uncured rubber compositions such as tire treads and other tire components. Often, it is considered herein, better cured silica-rich rubber composition physical properties might also be obtained, such as, for example, a better balance of high modulus and abrasion resistance, because of the avoidance of premature curing.

In practice, the composite of pre-reacted amorphous silica, mercapalkoxyosilane(s) and alkyl silane is mixed with the diene-based elastomer(s) and one or more rubber compounding ingredients. The composite may be added before, during or after any additional reinforcing fillers (e.g. other amorphous silica, carbon black and/or carbon black which contains silica domains on its surface) are mixed with the elastomer(s).

When reaction of the mercapto group of the mercaptoalkoxysilane component of the composite is desired to couple the amorphous silica to the diene-based elastomer is desired, a deblocking agent is added to the mixture to deblock the blocked mercaptosilane. The unblocking agent is added to facilitate the reactivity of the mercapto group. An exemplary amount of the unblocking agent may be, for example, about 0.1 to about 5 phr; more preferably in the range of from 0.5 to 3 phr.

In practice, the unblocking agent may be a nucleophile containing a hydrogen atom sufficiently labile such that hydrogen atom could be transferred to the site of the original blocking group to form the mercaptoalkoxysilane. Thus, with a blocking group acceptor molecule, an exchange of hydrogen from the nucleophile would occur with the blocking group of the blocked mercaptoalkoxysilane to form the unblocked mercaptoalkoxysilane and the corresponding derivative of the nucleophile containing the original blocking group. This transfer of the blocking group from the mercaptoalkoxysilane to the nucleophile could be driven, for example, by a greater thermodynamic stability of the products (mercaptoalkoxysilane and nucleophile containing the blocking group) relative to the initial reactants (blocked mercaptoalkoxysilane and nucleophile). For example, carboxyl blocking groups unblocked by amines would be seen to yield amides, sulfonyl blocking groups unblocked by amines would be seen to yield sulfonamides, sulfinyl blocking groups unblocked by amines would be seen to yield sulfinamides, phosphonyl blocking groups unblocked by amines would be seen to yield phosphonamides, phosphinyl blocking groups unblocked by amines would be seen to yield phosphinamides. What is important is that regardless of the blocking group initially present on the blocked mercaptosilane and regardless of the unblocking agent used, the initially substantially inactive (from the standpoint of coupling to the diene-based elastomer) blocked mercaptoalkoxysilane is substantially converted at the desired point in the rubber processing procedure to the active mercaptoalkoxysilane. It is noted that partial amounts of the nucleophile may be used (e.g. a stoichiometric deficiency), or even weak nucleophile, if one were to only partially unblock the blocked mercaptoalkoxysilane to control the degree of coupling involved with a specific rubber composition.

The unblocking agent could be added to the rubber mixture, for example, in the curative package (together with sulfur curative) or, alternatively, at any other mixing stage in the rubber mixing process as a single component, although practically it is added subsequent to the composite of pre-reacted amorphous silica and usually together with the curative in the final curative addition mixing stage.

Various classes of materials which can act as unblocking agents, but not normally effective as cure accelerators, allowing for selection between the two, are various oxides, hydroxides, carbonates, bicarbonates, alkoxides, phenoxides, sulfenamide salts, acetyl acetonates, carbon anions derived from high acidity C—N bonds, malonic acid esters, cyclopentadienes, phenols, sulfonamides, nitrites, fluorenes, tetra-alkyl ammonium salts, and tetra-alkyl phosphonium salts.

Representative examples of various unblocking agents are, for example, such nucleophiles as amines, imines and guanidines that contain at least one N—H bond. Some examples include: N,N′-diphenylguanidine, N,N′-di-ortho-tolylguanidine, hexamethylenetetramine and 4,4′-diaminodiphenylmethane.

Thus, when it is desired to unblock the blocked mercaptoalkoxysilane to enable the mercapto group (moiety) to interact with the elastomer(s) to thereby couple the pre-treated, hydrophobated, silica to the elastomer(s) it is seen that various unblocking agents may be used, depending somewhat upon the blocking moiety, or agent, used to block the chemical activity of the mercapto group of the blocked mercaptoalkoxysilane.

In practice, if alcohol or water is present in the mixture (a small amount of moisture is usually present) a catalyst (such as for example tertiary amines, Lewis acids or thiols) may conceivably be used to initiate and promote loss of the blocking agent and thereby liberate the corresponding chemical activity of the mercapto group of the mercaptoalkoxysilane. Alternately, the unblocking agent may be a nucleophile which contains a hydrogen atom sufficiently liable to liberate the chemical activity of the mercapto group of the blocked mercaptoalkoxysilane such that the hydrogen atom could be transferred to the site of the original blocking group used to block the mercaptoalkoxysilane. Therefore, with a blocking group acceptor molecule, an exchange of hydrogen would occur with the blocking group of the blocked mercaptoalkoxysilane. This transfer of the blocking group to the nucleophile could be driven, for example, by a greater thermodynamic stability of the products (mercaptoalkoxysilane and nucleophile containing the blocking group). For example, if the nucleophile were an amine containing an N—H bond, transfer of the blocking group from the blocked mercaptoalkoxysilane would unblock the mercapto group and one of several classes of amides corresponding to the type of blocking group used. For example, carboxy blocking groups unblocked by amines would yield amides, sulfonyl blocking groups unblocked by amines would yield sulfonamides, sulfinyl blocking groups unblocked by amines would yield sulfinamides, phosphonyl blocking groups unblocked by amines would yield phosphonamides, phosphinyl blocking groups unblocked by amines would yield phosphinamides. An important aspect is that regardless of the blocking group initially present on the blocked mercaptoalkoxysilane and regardless of the unblocking agent used, the initially substantially inactive mercapto group from the viewpoint of interacting with the diene-based elastomer(s) is substantially converted at a desired point of time in the rubber compounding process to the active mercapto group activity of the pre-treated silica.

In practice, the unblocking group may be added, for example, with the curative package (sulfur and appropriate accelerators) or, if desired, at another stage in the rubber mixing procedure.

Representative, of various nucleophiles may include, for example, primary and secondary amines, or amines which contain C═N double bonds such as imines or guanidines; provided however that the amine contains at least one C—N bond. Numerous examples of guanidines, amines and imines which may be useful are recited in Rubber Chemicals, J. V. Alphen, Plastics and Rubber Research Institute TNO, Delft Holland; 1973. Various examples include, for example, the aforesaid N, N′-diphenylguanidine, N,N′-di-ortho-tolylguanidine, hexamethylenetetramine and 4,4′-diaminodiphenylmethane. In addition, N,N′,N″-triphenylguanidine, orthobiguanide, cyclohexylethylamine, dibutylamine and 4,4′-diaminodiphenylmethane may be considered.

In practice, it is usually desired that the rubber composition is preferably essentially free of functionalized siloxanes, especially those of the type referenced in Australian Patent AU-A-10082/97, which is incorporated herein by reference. More preferably, the rubber composition is free of functionalized siloxanes.

In practice, where the composite of pre-reacted (pre-hydrophobated) precipitated silica aggregates are prepared from colloidal silica, such composite might be recovered, for example, from treated colloidal silica, for example as a treated silica hydrosol, with the aid of acid addition to the treated colloidal silica (for example, sulfuric acid or hydrochloric acid) followed by water washing and drying the recovered hydrophobated silica as a hydrophobated silica gel or as a hydrophobated precipitated silica.

While this invention is not intended to be directed to a specific preparation technique (preparation of silica hydrosols, recovery of silica gels and precipitated silicas, etc.) of the pre-hydrophobated precipitated silica itself, for education purposes in this regard, reference might be made to the aforesaid Condensed Chemical Dictionary and U.S. Pat. No. 5,094,829 as well as U.S. Pat. Nos. 5,708,069, 5,789,514 and 5,750,610 for a more detailed discussion.

Representative examples of mercaptoalkoxysilanes of Formula (II-A) and (II-B), prior to the blocking thereof with the “Z” moiety, are, for example, triethoxy mercaptopropyl silane, trimethoxy mercaptopropyl silane, methyl dimethoxy mercaptopropyl silane, methyl diethoxy mercaptopropyl silane, dimethyl methoxy mercaptopropyl silane, triethoxy mercaptoethyl silane, and tripropoxy mercaptopropyl silane.

In further accordance with this invention, a tire of this invention is provided with said component which may be, for example, a tire tread such as for example a tread, tread cap and/or tread base; tire sidewall; tire carcass component such as for example a carcass cord ply coat; tire sidewall stiffening insert; an apex adjacent to or spaced apart from a tire bead; tire chafer; and tire bead component.

Significantly, by the practice of this invention, an addition of a coupling agent to the rubber composition for an in-situ interaction is not considered herein as being necessary for the composite of pre-reacted (pre-hydrophobated) amorphous silica to effectively reinforce the rubber composition because the composite of the pre-reacted silica aggregates contain an integral coupling agent, namely the blocked mercaptoalkoxysilane.

In the practice of this invention, the various components of the tire may be a rubber composition comprised of various conjugated diene based elastomers. Such diene-based elastomers may be polymers and copolymers of conjugated dienes, such as, for example, isoprene and 1,3-butadiene, and copolymers of at least one conjugated diene hydrocarbon and vinyl aromatic compound selected from styrene and alphamethyl styrene, preferably styrene.

For example, representative of such elastomers are natural cis 1,4-polyisoprene rubber, synthetic cis 1,4-polyisoprene rubber, cis 1,4-polybutadiene rubber, high vinyl polybutadiene rubber having a vinyl 1,2 content in a range of about 10 percent to about 90 percent, styrene/butadiene copolymer (SBR) rubber (aqueous emulsion or organic solution polymerization prepared copolymers) and including organic solvent polymerization prepared SBR having a vinyl 1,2-content in a range of about 10 to about 90 percent based on its polybutadiene derived portion and a polystyrene content in a range of about 10 to about 60 percent based upon the copolymer, styrene/high trans 1,4-butadiene copolymer rubber having a trans-1,4 content in the range of about 40 to about 80 percent based on its polybutadiene derived portion, styrene/isoprene/butadiene terpolymer rubber, butadiene/acrylonitrile rubber, styrene/isoprene copolymer and isoprene/butadiene copolymer rubber, 3,4-polyisoprene rubber and trans 1,4-polybutadiene rubber.

Further representative of such elastomers are functionalized elastomers as, for example, amine and silane functionalized organic solution polymerization prepared styrene/butadiene copolymers (functionalized S-SBR's) and amine and silane functionalized organic solution polymerization prepared cis 1,4-polybutadiene elastomers may also be used.

Additional representative of such elastomers are, for example, organic solution polymerization prepared tin coupled elastomers such as for example, tin coupled styrene/butadiene copolymers may also be used.

Tin coupled copolymers of styrene/butadiene may be prepared, for example, by introducing a tin coupling agent during the styrene/1,3-butadiene monomer copolymerization reaction in an organic solvent solution, usually at or near the end of the polymerization reaction. Such coupling of styrene/butadiene copolymers is well known to those having skill in such art.

In practice, it is usually preferred that at least 50 percent and more generally in a range of about 60 to about 85 percent of the Sn (tin) bonds in the tin coupled elastomers are bonded to butadiene units of the styrene/butadiene copolymer to create Sn-dienyl bonds such as butadienyl bonds.

Creation of tin-dienyl bonds can be accomplished in a number of ways such as, for example, sequential addition of butadiene to the copolymerization system or use of modifiers to alter the styrene and/or butadiene reactivity ratios for the copolymerization. It is believed that such techniques, whether used with a batch or a continuous copolymerization system, is well know to those having skill in such art.

Various tin compounds, particularly organo tin compounds, may be used for the coupling of the elastomer. Representative of such compounds are, for example, alkyl tin trichloride, dialkyl tin dichloride, yielding variants of a tin coupled styrene/butadiene copolymer elastomer, although a trialkyl tin monochloride might be used which would yield simply a tin-terminated copolymer.

Examples of tin-modified, or coupled, elastomers are, for example, styrene/butadiene copolymer elastomers exemplified for example in U.S. Pat. No. 5,064,901.

Various additional commercially available amorphous silicas may also be added to the rubber composition together with the said pre-treated amorphous silica composite for the reinforcement of the diene based elastomers. Such silicas are typically characterized by the aforesaid BET and CTAB surface areas. Representative of such silicas, for example, only and without limitation, are silicas available from PPG Industries under the Hi-Sil trademark with designations 210, 243, etc; silicas available from Rhodia, with designations of Zeosil 1165MP and Zeosil 165GR, silicas available from Degussa AG with designations, for example, VN2 and VN3, and silicas available from Huber such as, for example, Zeopol 8745 and Zeopol 8715.

It is contemplated herein that a coupling agent be used in conjunction with such additional silica for rubber composition having a moiety reactive with hydroxyl groups (e.g. silanol groups) on said additional silica and another moiety interactive with at least one of said diene-based elastomers such as, for example a bis(3-triethoxysilyilpropyl)polysulfide having an average of from 2 to 4, and alternatively an average of from 2 to 2.6 or an average of from 3.5 to 4, connecting sulfur atoms in its polysulfidic bridge.

It is readily understood by those having skill in the art that the rubber composition of the tread rubber would be compounded by methods generally known in the rubber compounding art, such as mixing the various sulfur-vulcanizable constituent rubbers with various commonly used additive materials such as, for example, curing aids, such as sulfur, activators, retarders and accelerators, processing additives, such as oils, resins including tackifying resins and plasticizers, fillers, pigments, fatty acid, zinc oxide, waxes, antioxidants and antiozonants, peptizing agents and reinforcing materials such as, for example, carbon black. As known to those skilled in the art, depending on the intended use of the sulfur vulcanizable and sulfur vulcanized material (rubbers), the additives mentioned above are selected and commonly used in conventional amounts.

The presence and relative amounts of the above additives are not considered to be an aspect of the present invention, unless otherwise indicated, which is more primarily directed to a tire with a component of a rubber composition which contains the described particulate, pre-hydrophobated precipitated silica aggregates.

The tires can be built, shaped, molded and cured by various methods which will be readily apparent to those having skill in such art.

While certain representative embodiments and details have been shown for the purpose of illustrating the invention, it will be apparent to those skilled in this art that various changes and modifications may be made therein without departing from the spirit or scope of the invention.

1. A process of preparing a composite of hydrophobated amorphous silica which comprises reacting said an amorphous silica having hydroxyl groups on its surface with a combination of a blocked mercaptoalkoxysilane and an alkylsilane:
wherein said alkylsilane is of the general formula (I):
Zₙ-Si—R₄₋ₙ (I)
wherein R is a saturated alkyl radical having from one to 18 carbon atoms, n is a value of from 1 to 3 and Z is a radical selected from a chlorine, bromine and alkoxy radicals,
wherein said blocked mercaptoalkoxysilane is selected from blocked mercaptoalkoxysilanes of the general formulas (II-A) and (II-B):
[[(ROC(═O))ₚ-(G)ⱼ]ₖ-Y—S]ᵣ-G-(SiX₃)ₛ (II-A)
[(X₃Si)_{q}-G]ₐ-[Y—[S-G-SiX₃]_{b}]_{c} (II-B)
wherein Y is a polyvalent species (Q₂)A(=E) a radical selected from the group consisting of —C(═NR)—; —SC(═NR)—; —SC(═O)—; (—NR)C(═O)—;
(—NR)C(═S); —OC(═O)—; —OC(═S)—; —C(═O)—; —SC(═S)—; —C(═S)—; —S(═O); —OS(═O)₂—; (—NR)S(═O)₂—; —SS(═O)—; —OS(═O)—; (—NR)S(═O)—; —SS(═O)₂—; (—S)₂P(═O)—; —(—S)P(═O)—; —P(═S)(−)₂; (—NR)₂P(═O)—; (—NR)(—S)P(═O)—; (—O)₂P(═O)—; —(—O)P(═O)—; —(—NR)P(═O)—; (—NR)₂P(═S)—; (—NR)(—S)P═S)—; (—O)(—NR)P(═S)—; (—O)(—S)P(═S)—; (—O)₂P(═S)—; —(—O)P(═S)—; and —(—NR)P₉═S)—;
wherein the atom (A) is attached to the unsaturated heteroatom (E) which is attached to the sulfur, and the sulfur is linked via a group G to the silicon atom;
wherein each R is independently selected from hydrogen, and straight, cyclic or branched alkyl radicals containing from 1 to 18 carbon atoms and which may or may not contain unsaturation, alkenyl groups, aryl groups, aralkyl groups containing from 1 to 18 carbon atoms;
wherein each G is independently selected from a monovalent or polyvalent group derived from substitution of alkyl, alkenyl, aryl or aralkyl group(s) wherein G can contain from 1 to 18 carbon atoms, providing however that G is not such that said mercaptoalkoxysilane contains an alpha-, or beta-unsaturated carbonyl including a carbon-to-carbon double bond next to the thiocarbonyl group, wherein if G is univalent (e.g. if p=0), then G can be a hydrogen atom;
wherein X is independently selected from the group consisting of —Cl, -GR, RO—, RC(═O)—, R₂C═NO—, R₂NO—, or R₂N—, —R, —(OSiR₂), (OSiR₃), wherein each R and G is as above and at least one X is not —R;
wherein Q is selected from oxygen, sulfur or (—NR—);
wherein A is selected from carbon, sulfur, phosphorous or sulfonyl;
wherein E is selected from oxygen, sulfur or NR;
wherein p is 0 through 5; r is 1 through 3; z is 0 through 2; q is 0 through 6; a is 0 through 7; b is 1 through 3; j is 0 to 1, but j is 0 only if p is 1 and c is from 1 through 6, wherein j is preferably from 1 through 4; t is 0 through 5; s is 1 through 3; k is 1 or 2; and
wherein,
(A) if A is carbon, sulfur or sulfonyl, then
(1) a+b=2 and
(2) k=1;
(B) if A is phosphorus and a+b=c unless both
(1) c>1 and
(2) b=1, in which case a=c+1, and
(C) if A is phosphorus, then k is 2.

2. The process of claim 1 wherein alcohol and hydrogen halide byproducts formed by chemical reaction of said hydroxyl groups on said amorphous silica with alkoxy groups of said blocked mercaptoalkoxysilane and with alkoxy and/or halogen groups of said alkylsilane are removed from said hydrophobated amorphous silica composite.

3. A composite prepared according to the process of claim 1.

4. A composite prepared according to the process of claim 2.

5. A method of preparing a rubber composition comprises:
(A) mixing at least one conjugated diene-based elastomer with said hydrophobated amorphous silica composite of claim 4;
(B) mixing an unblocking agent with the resulting mixture of step (A), and
(C) sulfur vulcanizing the resulting mixture.
wherein chemical activity of the blocked mercapto group of said hydrophobated amorphous silica is substantially blocked insofar as interaction with said diene-based elastomer is concerned, and
wherein said blocked mercapto group of said hydrophobated amorphous silica is unblocked by said unblocking agent, and
wherein said unblocked mercapto group interacts with at least one of said diene-based elastomers to couple said hydrophobated amorphous silica to at least one of said elastomers.

6. The method of claim 5 wherein said blocked mercaptoalkoxysilane is the blocked mercaptoalkoxysilane of Formula (II-A).

7. The method of claim 5 wherein said blocked mercaptoalkoxysilane is the blocked mercaptoalkoxysilane of Formula (II-A) wherein r=1 and s=1; Y is —C(═O)—; and X is RO—.

8. The method of claim 5 wherein said unblocking agent is selected from at least one of N,N′-diphenylguanidine and N,N′-di-ortho-tolylguanidine.

9. The method of claim 5 which comprises, based on parts by weight per 100 parts by weight (phr) of diene-based elastomer:
(A) mixing at least one conjugated diene-based elastomer with about 10 to about 120 phr of reinforcing filler at a temperature in a range of from about 140° C. to about 170° C., wherein said reinforcing filler is comprised of
(1) said hydrophobated amorphous silica composite of claim 4, and optionally,
(2) at least one additional reinforcing filler selected from carbon black and an additional synthetic amorphous silica, and optionally, a coupling agent for said additional synthetic amorphous silica,
(B) mixing an unblocking agent with the mixture of step (A), at a temperature in a range of from about 100° C. to about 125° C. and concurrently or thereafter mixing sulfur curative therewith at a temperature in a range of from about 100° C. to about 125° C., and thereafter,
(C) curing the resulting mixture at an elevated temperature in range of from 140° C. to about 170° C.

10. The method of claim 5 wherein said alkylsilane is selected from the group consisting of trichloro methyl silane, dichloro dimethyl silane, chloro trimethyl silane, trimethoxy methyl silane, dimethoxy dimethyl silane, methoxy trimethyl silane, trimethoxy propyl silane, trimethoxy octyl silane, trimethoxy hexadecyl silane, dimethoxy dipropyl silane, triethoxy methyl silane, triethoxy propyl silane, triethoxy octyl silane, and diethoxy dimethyl silane.

11. The method of claim 5 wherein for blocked mercaptoalkoxysilanes: Y is RC(═O)—, p=0, r=1, s=1, X is (RO—), R is an alkyl group having from 1 to 18 carbon atoms, and G is a monovalent alkyl radical having from 1 to 18 carbon atoms.

12. The method of claim 5 wherein said blocked mercaptoalkoxysilanes are selected from at least one of the group consisting of 2-triethoxysilyl-1-ethyl thioacetate; 2-trimethoxysilyl-1-ethyl thioacetate; 2-(methyldimethoxysilyl)-1-ethyl thioacetate; 3-trimethoxysilyl-1-propyl thioacetate; triethoxysilylmethyl thioacetate; trimethoxysilylmethyl thioacetate; triisopropoxysilylmethyl thioacetate; methyldiethoxysilylmethyl thioacetate; methyldimethoxysilylmethyl thioacetate; methyldiisopropoxysilylmethyl thioacetate; dimethylethoxysilylmethyl thioacetate; dimethylmethoxysilylmethyl thioacetate; dimethylisopropoxysilylmethyl thioacetate; 2-triisopropoxysilyl-1-ethyl thioacetate; 2-(methyldiethoxysilyl)-1-ethyl thioacetate; 2-(methyldiisopropoxysilyl)-1-ethyl thioacetate; 2-(dimethylethoxysilyl)-1-ethyl thioacetate; 2-(dimethylmethoxysilyl)-1-ethyl thioacetate; 2-(dimethylisopropoxysilyl)-1-ethyl thioacetate; 3-triethoxysilyl-1-propyl thioacetate; 3-triisopropoxysilyl-1-propyl thioacetate; 3-methyldiethoxysilyl-1-propyl thioacetate; 3-methyldimethoxysilyl-1-propyl thioacetate; 3-methyldiisopropoxysilyl-1-propyl thioacetate; 1-(2-triethoxysilyl-1-ethyl)-4-thioacetylcyclohexane; 1-(2-triethoxysilyl-1-ethyl)-3-thioacetylcyclohexane; 2-triethoxysilyl-5-thioacetylnorbornene; 2-triethoxysilyl-4-thioacetylnorbornene; 2-(2-triethoxysilyl-1-ethyl)-5-thioacetylnorbornene; 2-(2-triethoxysilyl-1-ethyl)-4-thioacetylnorbornene; 1-(1-oxo-2-thia-5-triethoxysilylpenyl)benzoic acid; 6-triethoxysilyl-1-hexyl thioacetate; 1-triethoxysilyl-5-hexyl thioacetate; 8-triethoxysilyl-1-octyl thioacetate; 1-triethoxysilyl-7-octyl thioacetate; 6-triethoxysilyl-1-hexyl thioacetate; 1-triethoxysilyl-5-octyl thioacetate; 8-trimethoxysilyl-1-octyl thioacetate; 1-trimethoxysilyl-7-octyl thioacetate; 10-triethoxysilyl-1-decyl thioacetate; 1-triethoxysilyl-9-decyl thioacetate; 1-triethoxysilyl-2-butyl thioacetate; 1-triethoxysilyl-3-butyl thioacetate; 1-triethoxysilyl-3-methyl-2-butyl thioacetate; 1-triethoxysilyl-3-methyl-3-butyl thioacetate; 3-trimethoxysilyl-1-propyl thiooctoate; 3-triethoxysilyl-1-propyl thiopalmitate; 3-triethoxysilyl-1-propyl thiooctoate; 3-triethoxysilyl-1-propyl thiobenzoate; 3-triethoxysilyl-1-propyl thio-2-ethylhexanoate; 3-methyldiacetoxysilyl-1-propyl thioacetate; 3-triacetoxysilyl-1-propyl thioacetate; 2-methyldiacetoxysilyl-1-ethyl thioacetate; 2-triacetoxysilyl-1-ethyl thioacetate; 1-methyldiacetoxysilyl-1-ethyl thioacetate; 1-triacetoxysilyl-1-ethyl thioacetate; 3-ethoxydidodecyloxy-1-propyl thioacetate; 3-ethoxyditetradecyloxy-1-propyl thioacetate; 3-ethoxyditetradecyloxy-1-propyl-thiooctoate; 3-ethoxydidodecyloxy-1-propyl-thiooctoate; 3-ethoxyditetradecyloxy-1-propyl thioacetate; 3-ethoxydidodecyloxy-1-propyl-thiooctate; 3-ethoxyditetradecyloxy-1-propyl-thiooctoate; tris-(3-triethoxysilyl-1-propyl)trithiophosphate; bis-(3-triethoxysilyl-1-propyl)methyldithiophosphonate; bis-(3-triethoxysilyl-1-propyl)ethyldithiophosphonate; 3-triethoxysilyl-1-propyldimethylthiophosphinate; 3-triethoxysilyl-1-propyldiethylthiophosphinate; tris-(3-triethoxysilyl-1-propyl)tetrathiophosphate; bis-(3-triethoxysilyl-1-propyl)methyltrithiophosphonate; bis-(3-triethoxysilyl-1-propyl)ethyltrithiophosphonate; 3-triethoxysilyl-1-propyldimethyldithiophosphinate; 3-triethoxysilyl-1-propyldiethyldithiophosphinate; tris-(3-methyldimethoxysilyl-1-propyl)trithiophosphate; bis-(3-methyldimethoxysilyl-1-propyl)methyldithiophosphonate; bis-(3-methyldimethoxysilyl-1-propyl)ethyldithiophosphonate; 3-methyldimethoxysilyl-1-propyldimethylthiophosphinate; 3-methyldimethoxysilyl-1-propyldiethylthiophosphinate; 3-triethoxysilyl-1-propylmethylthiosulphate; 3-triethoxysilyl-1-propylmethanethiosulphonate; 3-triethoxysilyl-1-propylethanethiosulphonate; 3-triethoxysilyl-1-propylbenzenethiosulphonate; 3-triethoxysilyl-1-propyltoluenethiosulphonate; 3-triethoxysilyl-1-propylnaphthalenethiosulphonate; 3-triethoxysilyl-1-propylxylenethiosulphonate; triethoxysilylmethylmethylthiosulphate; triethoxysilylmethylmethanethiosulphonate; triethoxysilylmethylethanethiosulphonate; triethoxysilylmethylbenzenethiosulphonate; triethoxysilylmethyltoluenethiosulphonate; triethoxysilylmethylnaphthalenethiosulphonate and triethoxysilylmethylxylenethiosulphonate.

13. The method of claim 5 wherein the unblocking agent is a nucleophile containing a hydrogen atom sufficiently labile such that hydrogen atom can be transferred to the site of the original blocking group to form the mercaptoalkoxysilane.

14. The method of claim 5 wherein said unblocking agent is a nucleophile selected from the group consisting of amines, imines and guanidines that contain at least one N—H bond.

15. The method of claim 5 wherein said rubber composition is free of functionalized siloxanes.

16. A rubber composition prepared by the method of claim 5.

17. The rubber composition of claim 16 wherein said diene-based elastomer is comprised of at least one of homopolymers and copolymers of at least one of isoprene and 1,3-butadiene, copolymers of styrene and/or alphamethylstyrene with at least one of isoprene and 1,3-butadiene, tin coupled organic solution polymerization prepared styrene/butadiene copolymers and amine and silane functionalized organic solution polymerization prepared styrene/butadiene copolymers and cis 1,4-polybutadiene elastomers.

18. An article of manufacture having at least one component comprised of the rubber composition of claim 16.

19. A tire having at least one component comprised of the rubber composition of claim 16.

20. A tire having at least one component comprised of the rubber composition of claim 17.
